(19) United States
(12) Patent Application Publication
(10) Pub. No.: US 2026/0349935 A1
(43) Pub. Date: Nov. 5, 2026

(54) METHOD FOR CONNECTING A MOBILE DEVICE TO A PERIPHERAL DEVICE

(71) Applicant: SITA Information Networking Computing UK Limited, Hayes (GB)

(72) Inventors: Abhiskek Saxena, Hayes (GB); Andrew Glading, Hayes (GB); Azar Khan, Hayes (GB); Chris Martin, Hayes (GB); Mohammed Altaf, Hayes (GB); Mukesh Santhanam, Hayes (GB); Stephen Wheelan, Hayes (GB); Steve Goddard, Hayes (GB); Surinder Singh, Hayes (GB); Tamim Khan, Hayes (GB)

(21) Appl. No.: 19/710,976

(22) Filed: Jun. 17, 2026

Related U.S. Application Data
(63) Continuation of application No. PCT/GB2023/053313, filed on Dec. 19, 2023.

(51) Int. Cl. G06F 13/10; G06F 3/12; G06F 9/54

(52) U.S. Cl. CPC G06F 13/102; G06F 3/1204; G06F 3/1229; G06F 3/1236; G06F 3/1243; G06F 3/1292; G06F 9/547

(57) ABSTRACT

A method, system, and computer program product for connecting an application to a peripheral device. A location identifier associated with the peripheral device's location is received and used to reserve that location via an application programming interface. A connection is then formed between the application and the peripheral device at the reserved location, defining a data-exchange route through the API. The reservation grants exclusive access to the device for the duration of use, preventing other applications from connecting to the same location, and is released upon completion of a job, inactivity, or a disconnection request.

### CROSS-REFERENCE TO RELATED APPLICATIONS

The application is a continuation of International Application No. PCT/GB2023/053313, filed on Dec. 19, 2023, and entitled “METHOD FOR CONNECTING A MOBILE DEVICE TO A PERIPHERAL DEVICE,” the disclosure of which is hereby incorporated by reference in its entirety.

### FIELD OF INVENTION

The present invention relates to a method for connecting to a peripheral device. More specifically, the present invention relates to a method for exchanging data with a peripheral device at a reserved location through an application programming interface to enable users to perform airline operations such as scanning passports, or printing bag tags and boarding passes.

### BACKGROUND

In the transportation industry (e.g. relating to aviation, buses, trains, etc) there has been a move towards the implementation of self-service infrastructure that enables a passenger to carry out tasks independently for which an agent was traditionally needed. An example of such a task is the printing and application of bag tags, bag tags being labels attachable to an item of luggage and comprising the information necessary to route said item of luggage to its destination.

The self-service infrastructure of today is large. This is a result of the need to install the applications (i.e. software) that enable a customer to undertake tasks, such as generating and printing bag tags independently, on the infrastructure itself. The large footprint of such self-service infrastructure makes its implementation in smaller spaces where it might be useful (for example on a bus or in a hotel lobby) difficult. Furthermore, the self-service infrastructure of today is purely designed for passengers to use and offers no useability for members of staff/agents to assist customers when necessary.

Accordingly, known systems are unable to effectively cater for the needs of both passengers and agents using a minimal amount of infrastructure. Therefore, there is a need for commonly used infrastructure within the travel industry that is able to accommodate the forecast growth in passenger numbers in the coming years. Accordingly, this leads to a need to retain both self-service infrastructure and separate infrastructure for agents/members of staff to use and for self-service infrastructure to have a smaller footprint while retaining flexible usability.

### SUMMARY OF INVENTION

The invention is defined by the independent claims, to which reference should now be drawn. Preferred features are set out in the dependent claims.

In a first aspect of the invention, a method for connecting an application to a peripheral device comprises receiving a location identifier associated with a location of a peripheral device, reserving the location of the peripheral device based on the received location identifier, the location being reserved via an application programming interface, and forming a connection between the application and the peripheral device at the reserved location, the connection defining a route for exchanging data between the application and the peripheral device via the application programming interface.

Advantages associated with the first aspect of the invention are described herein.

Some embodiments further comprise sending print data to the peripheral device, or receiving scan data from the peripheral device.

In some embodiments, the peripheral device is a bag tag printer.

Some embodiments further comprise printing a bag tag at the peripheral device.

Some embodiments further comprise retrieving the location identifier from the peripheral device.

In some embodiments, retrieving the location identifier from the peripheral device comprises scanning a barcode displayed on a display screen of the peripheral device.

In some embodiments, the application is a web application and the connection between the peripheral device and the web application is formed via the application programming interface.

Some embodiments further comprise sending a location reservation call from the web application to the application programming interface to reserve the location of the peripheral device.

Some embodiments further comprise sending a subscription call from the web application to the application programming interface to form an ongoing connection therebetween.

In some embodiments, the web application is configured to interact with an airline departure control system to retrieve passenger-related information and to populate the print data with the passenger-related information.

In some embodiments, the web application interacts with the airline departure control system via an integration service.

Some embodiments further comprise sending a request from the web application to the airline departure control system to produce the print data.

Some embodiments further comprise receiving the print data at the web application from the airline departure control system for subsequent routing to the peripheral device.

Some embodiments further comprise releasing the reserved location of the peripheral device after executing a print job at the peripheral device based on the print data.

In a second aspect a computer program product is configured, when executed, to perform the method according to the first aspect.

Advantages associated with the second aspect of the invention are substantially the same as those described for the first aspect of the invention.

### BRIEF DESCRIPTION OF THE DRAWINGS

An embodiment of the invention will now be described, by way of example only, and with reference to the accompanying drawings, in which:

FIG. 1 is a schematic diagram showing the system architecture of an embodiment of the invention

FIG. 2 is a schematic diagram of an example method according to embodiments of the invention; and

FIGS. 3A to 3I are examples of a graphical user interface (GUI) of an application for implementing the invention.

The following description is of a system for use in the aviation industry, but this is exemplary and other applications of the invention will also be discussed. For example, the system may be used in any environment where infrastructure is shared. The system may be embodied in a hosted system which may use Application Programming Interface (API) communications protocols to communicate with external systems such as reservation systems or departure control systems.

In this particular embodiment API services or modules are built on a Microsoft AZURE™ platform. However, other platforms known to the skilled person may be used, such as an Amazon™ Web Services (AWS) cloud platform, an IBM™ cloud platform, or a Google™ cloud platform.

Further, it will be appreciated that the functionality may be implemented in any programming language, for example, html 5, C++™, JAVA™, and .xml may be used as well as other programming languages which will be known to the skilled person. For example, embodiments of the invention may use one of these programming languages to provide a web-based service.

The problems discussed above are ameliorated by the claimed invention. In particular, embodiments of the claimed invention enable airline and airport applications and software run by peripheral devices, such as printers and scanners, to be located in the cloud rather than on the peripheral devices. This may provide the flexibility for user interface devices such as workstations, tablets, smart phones to evolve independent of devices such as a passport scanner, chip and pin for payment, self-bag drop and so on. Further, customers may configure any of these devices easily and conveniently through the use of a mobile device to access one or more backend services that enable the user to configure a peripheral device.

Additionally, upgrading software does not need to take place at the device level, which can be time consuming. Instead, the software and applications may be updated and maintained centrally, with the peripheral devices accessing the software services and applications on the cloud via an internet connection.

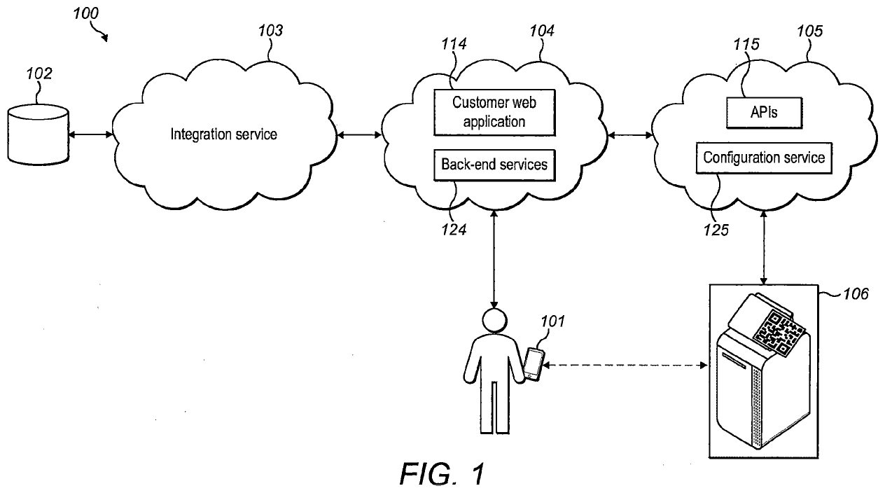

FIG. 1 is a schematic diagram of an example architecture of a system 100 embodying the invention. The example system 100 of FIG. 1 includes a mobile device 101, a departure control system (DCS) provider 102, an integration service 103, a cloud services provider 104, an API provider 105, and one or more peripheral devices 106.

Hosting the optional integration service 103, cloud services provider 104 and API provider 105 on remote servers advantageously enables the provision of a distributed system, whereby the remote servers and hardware are located in different physical locations. For example, the one or more remote servers may be physically located in a particular state, such as California in the United States, while the customer and peripheral device to be accessed may be located, for example, in Bohemia in the United States. The DCS may be hosted, for example, in a different region, location or country, such as Germany.

The mobile device 101 may be any smart telephone, tablet or any other portable computing device that passengers may bring to the airport environment in order to perform the function of printing boarding passes or bag tags or making payments such as payments for overweight baggage and so on. In essence, the invention provides a way for customers to access infrastructure, such as peripheral devices 106, via their mobile device. In preferred embodiments, the mobile device 101 provides an interface to enable a user to access one or more services located on the cloud services provider 104. The mobile device 101 may be connected to cloud services provider 104 via a web-based browser through an internet connection, or local access network. This may be facilitated using wired or wireless communications protocols such as 4G, 5G, WiFi or the like.

In the air transport industry (ATI), a DCS 102 typically interacts with reservation systems to manage information required for airport check-in, the printing of boarding cards, the acceptance of baggage, aircraft boarding, load control and aircraft checks. Similar systems operate in other transport industries. The DCS 102 receives reservation data from the reservation systems in a Passenger Name Record (PNR), which may then be updated to indicate a passenger has checked-in, boarded or arrived at their destination. In instances where passengers check-in in advance through a smart device or web access, the advance check-in is recorded in the PNR received by the DCS 102. The hardware and software components of the DCS 102 are well known, as are the communications interfaces and the messaging standards.

Information from DCS 102 is provided to the cloud service provider 104 and API provider 105 via an optional integration service 103. The purpose of the integration service 103 is to enable effective communications between an airline hosted DCS 102 and the cloud services provider 104. In preferred embodiments, the integration service 103 is also located on the cloud, for example on Microsoft's Azure™ platform.

The cloud services provider 104 may comprise a cloud-based data centre or one or more computer servers. In preferred embodiments, the cloud services provider 104 hosts a customer web application 114 and one or more back-end services 124. In some embodiments, the cloud service provider 104 may be provided by third parties and would then be communicatively coupled to the integration service 103 and API provider 105 via an interface.

The Customer web application 114 may be an application for use by passengers, or may be an application for use by airport agents. In some embodiments, the customer application 114 is run on the mobile device 101 via a web-based browser to a native application stored on the device. The mobile device 101 therefore provides a user interface for interacting with one or more back-end systems, and peripheral devices.

The one or more back-end services 124 may be managed by a back end application, which controls connections to peripheral devices 106 and controls the session.

In preferred embodiments, the API provider 105 is a platform that functions as a communications layer between one or more peripheral devices 106 and one or more webbased applications, such as customer web application 114. Accordingly, API provider 105 enables communications between devices that are not within the same physical environment.

In preferred embodiments, the API provider 105 is hosted on a cloud-based server, such as Microsoft™ AZURE™ and may include one or more API services 115 that provide data exchange between the customer web application 114 and back-end services 124 located on cloud services provider 104. The API services may also exchange data with one or more peripheral devices 106.

A key advantage of the API provider 105 is that APIs are hosted and run within the cloud. Accordingly, the amount of functionality required to be performed by the one or more peripheral devices 106 can be reduced by relocating this functionality to the cloud. Reducing the functionality and applications required to be installed on the peripheral devices means that certifying and installing software does not need to be carried out at the device-level, which can be extremely time consuming if the devices are within a distributed environment. Instead, the certification and installation of software occurs within the cloud on API provider 105 that is then accessed by the peripheral devices 106 via an internet connection. This further results in each peripheral device requiring less physical space, and also means that a single peripheral device does not need to perform all required functions. For example, for a passenger to print a bag tag or boarding pass they would need to interact with a device such as a traditional certified check in kiosk that is capable of reading passports, printing and scanning boarding cards, weighing baggage, and printing bag tags and baggage labels. However, the present invention allows for remote check-in and baggage collection as non-certified scanners and printers may be used. Accordingly, the peripheral devices 106 may be deployed in non-traditional locations such as buses, hotels, train stations and so on, where traditional certified kiosks cannot be installed because of their large size.

In preferred embodiments, the one or more API services 115 include one or more of: a BagDrop API, which enables interactions with self-baggage drop (SBD) devices; a Baggage Scales API, which enables interactions with baggage scales (BWS) devices; a GateAccess API, which enables interactions with boarding gate readers (BGR/BCR) and self-boarding gates (SBG); a Payment API, which enables interactions with payment devices (PMT); a Print API, which enables interactions with print devices for printing boarding passes, baggage tags, and reports; a Scan API, which enables interactions with scanning devices (OCR, LSR, MSR) for reading travel documents, such as passports, barcodes, and frequent flier cards; a Session API, which enables the creation and management of subscriptions and connections to devices on common-use platforms; and an API for driving one or more belts of one or more peripheral devices.

The API services 115 have two main functions. Firstly, they transmit acknowledgement messages in response to receiving messages from applications such as customer web application 114.

Secondly, they route messages to the correct peripheral device 106 via a configuration service 125 and a respective device service. In preferred embodiments, the device service may be provided as an API service within the API provider 105 and provides an interface with any of the one or more peripheral devices 106. This allows the services provided by any of the one or more shared peripheral devices 106 to be listed, and made available for use. For example, a peripheral device 106 that is a printer coupled to a networked workstation would be listed by the device services API as a device capable of performing print functions. Further detail regarding the nature of the printing may be provided by the device services API. For example, it may indicate that the printer is capable of printing a bag tag which can be attached to a passenger's luggage. Similarly, the device services API may indicate that the printer is able to print a boarding pass in a particular format or size or following a particular style sheet or table.

In some embodiments, the API services 115 further comprise a translator API that translates between the different protocols used. This may involve translating commands between the API provider 105 and the cloud services provider 104. In addition, the translator API may perform authentication functions to check that messages received from the customer application 114 are associated with a genuine user. Accordingly, although not a required component, providing the translator API is particularly advantageous when integrating legacy applications and devices.

The foregoing API functions and services allow messages relating to printing a boarding pass, scanning a boarding pass, or reading a credit card using near-field communications (NFC) and the like, to be provided to the relevant peripheral device capable of performing such actions. Thus, the API services 115 are able to route messages to the correct service while also sending acknowledgement messages to confirm receipt of the service request.

### Configuration Service (One Config Tool)

In preferred embodiments, the API provider 105 also includes a configuration service 125. The configuration service 125 (e.g. One Config Tool) may configure one or more touchpoints (e.g. a peripheral printing device) and map them with the API service layer, thereby linking the end user API services with the physically configured end points. Therefore, the configuration service 125 may hold data comprising a list of peripheral devices and their configurations and capabilities, or be communicatively connected to a storage holding such data. For example, such data may include information relating to multiple printers, including their configurations (e.g. interface configurations such as COM port configurations) and capabilities (e.g. some of the printers may be capable of functioning as bag tag printers, whereas other printers may be capable of functioning as ATB printers for printing boarding passes and/or baggage payment receipt).

Optionally, the configuration service 125 enables the configuration of both hardware and software within system 100 by mapping connections between one or more digital services or applications to the physical endpoints associated with one or more peripheral devices. For example, the configuration service 125 enables the configuration of one or more peripheral devices 106 such as workstations, kiosks and mobile devices, while also configuring airport and airline applications. However, it will be appreciated that different configuration service 125 comprises different sub-services, for example for separately configuring hardware or software components. The configuration service 125 may seamlessly integrate API data with a device interface service (flex adapter) of the one or more peripheral devices 106. This allows the system to make use of the full capabilities of the devices 106. Accordingly, users may configure the desired applications or devices that are available at a specific location via the configuration service 125.

The main purpose of the configuration service 125 is to configure system 100 in order to allow customers to use a mobile device 101 to perform an airline operation, such as checking in or printing a bag tag, using one or more peripheral devices 106. As indicated further below, the peripheral devices 106 may be located in different environments, such as an Airport site or an Off Airport site. This enables the centralized management of hardware and software for airport-related operations (such as check in, printing boarding tags and bag tags, and bag drop) both at airports and at off-airport locations, and enables airport staff to use mobile devices to reduce queue length. Providing additional functionality at off-airport sites advantageously reduces congestion in airports, improves convenience for passengers and reduces the cost of airport infrastructure.

In order to facilitate these advantages, it is important to uniquely identify the location of each peripheral device 106 to enable a user to be able to successfully interact with that device. This is achieved using a Location ID having standard notation that incorporates IATA airport codes, where appropriate, as further described below.

Location ID Each of the one or more peripheral devices 106 may be paired with a unique Location Identifier (ID), which may be represented by a 2D barcode, QR code, or other means of representing the Location ID in a machine-readable manner.

Preferably, the location ID follows the format of any one of the following examples:
1. A-LHR-LHRACKA001
2. OA-UK-LON-HTL-HILTON01-LHRLOACOQ1

### EXAMPLE 1

In this example, the Location ID also defines a location within an airport. In Example 1, the exact location is defined as follows:
Category: A=airport
Airport IATA code: LHR=London Heathrow
Work Station: LHR1CKC001=LHR Terminal 1, check in row 1, workstation 1

### EXAMPLE 2

In this example, the Location ID defines a location outside an airport. In Example 2, the exact location is defined as follows:
Category: OA=Off-Airport Site
Location: UK-LON=London, UK
Site Type: HTL=Hotel
Hotel Name: HILTON01=The Hilton

Work Station: LHRLOAC001=LHR Hilton workstation 1

These examples define a relative location or a location which may be at any location within one or more predetermined areas. The location identifiers may define areas, regions or volumes within two dimensional or three-dimensional space. The two-or three-dimensional space may be defined by one or more x, y or z coordinates which are associated with each area or space. The coordinates defining each area or space may be stored in a data base along with the associated location identifier defining each area or space.

It will be appreciated that the location identifier does not define locations relative to a single point of origin. This is in contrast a coordinate system such as a longitude and latitude coordinate system in which all locations are defined relative to a single point of origin. Rather, each location identifier is associated with a predetermined location. A hierarchical tree defining the location relative to each predetermined location is provided. This has the benefit that the location identifier may be interpreted by the skilled person and the hierarchical structure understood without the need to refer to a database of acronyms. This allows for the hierarchical structure to be easily expanded as necessary.

In the above examples, the location identifier may define different regions. Usually, at least some of the different regions overlap with one or another or may be contained wholly within another region. Thus, an airport may be thought of as a region 1, an administration area may be thought of as a sub-region 2, and a conference room may be thought of as a subregion 3 of sub-region 2. Sub-region 3 may be wholly contained within sub-region 2. Similarly, sub-region 2 may be wholly contained within region 1.

Multiple peripheral devices 106 may be provided at a specific location. Each device usually has a unique identifier, for example a device identifier. The device identifier is usually in the form of an alphanumeric string.

Further, in order to distinguish between the different functionality of multiple peripheral devices 106 at a particular location, each device 106 may have an associated device type or generic device label definition. For example, a device type of LSR may indicate a barcode scanner used to scan a boarding pass or bag tag. A device type or label of MSR may indicate that the device is a Magnetic Swipe Reader used to read a credit card, or loyalty card. Other device types or labels may be BTP indicating that the device is a Bag Tag Printer or Boarding Pass Printer, referred to as ATP (Automated Ticketing and Boarding Printer) which indicating that the device is a Boarding Pass Printer. The combination of device type and location identifier allows a particular device to be uniquely identified in a particular region of the airport.

The one or more peripheral devices 106 may comprise any one or more of a printer or scanner or reader, check-in counter device, boarding counter device, kiosk (such as a kiosk for printing a boarding pass or bag tag), bag-drop counter device, security screening device or self-boarding gate device. In other words, the peripheral devices 106 relate to shared infrastructure computing devices. The scanner or reader is usually configured to read a boarding pass or a bag tag, passport or identity card or other machine-readable document. This is usually performed using an optical scan of the boarding pass or bag tag using known Optical Character Recognition (OCR) algorithms. As indicated above, the peripheral devices 106 within system 100 may be distributed within different physical environments. For example, a peripheral device for scanning a passport to enable a customer to check in may be located at an Off Airport site, for example within a hotel or on a bus. Conversely, a peripheral device for printing a bag tag may be located at an Airport site, for example within the departures concourse.

### Multiple Peripheral Devices

If a location ID is associated with multiple peripheral devices 106, then the location ID may be paired with a device type label in order to distinguish between different devices at a particular location. Example of device type labels include ATP (automated ticketing and boarder printer), BTP (bag tag printer), LSR (bar code scanner), OCR (optical character recognition), or MSR (magnetic strip reader). Alternatively, a unique device identifier may be used to distinguish between different peripheral devices within the same location ID.

### Device Interface (Flex Adaptor)

Each peripheral device 106 includes a device interface service (Flex adaptor) that sits on the respective peripheral device 106 and allows an airline app running on mobile device 101 to connect with existing back-end systems and peripheral devices. The Flex adapter may be implemented in forms of a software component, and provide a translation layer between legacy Virtual Peripheral Service (VPS) and VPS using AEA communication language with the Azure IOT cloud hub. This enables simplified API communications from cloud to a workstation (e.g. a touch point) providing high level API service to a user (e.g. end user).

In preferred embodiments, the device interface service may comprise a module installed on each of the one or more peripheral devices 106. An advantage of the device interface is that it links the VPS and legacy API functionality, and so allows passengers to generate a bag tag by scanning a QR code using an airline application running on a mobile device. Advantageously, the use of the device interface allows an API approach even with legacy systems that are not compatible with API's. Therefore, the primary function of the device interface service is converting communications from applications and APIs into an intelligible language for the VPS.

Once the location ID has been determined as outlined above, the location ID is passed to the device interface service, which also obtains a security certificate on connecting to the configuration service 125. The configuration service 125 receives a request from the device interface, and uses the determined location ID to determine what devices are associated with a particular location and the particular configurations needed for those devices. The security certificate and location ID allows the configuration service 125 to provide a set of configuration settings required for the device at the specified location.

The device interface service allows for legacy devices, such as bag tag printers and boarding pass printers, to be remotely connected. Each particular legacy device type is assigned to a respective port. For example, a boarding pass printer may be assigned to a first port, while one or more bag tag printers may be assigned to a second port. Thus, the device interface service may determine the type of printer based on which printing port the printer has been assigned to.

Unless indicated otherwise, the functional components described above may be implemented using API calls, such as a Representational State Transfer (REST) API call using an HTTP protocol. Thus, data within messages exchanged between these components is usually in the format of an alpha-numeric string and an associated field defining the type of data, which may also be in an alpha-numeric string format.

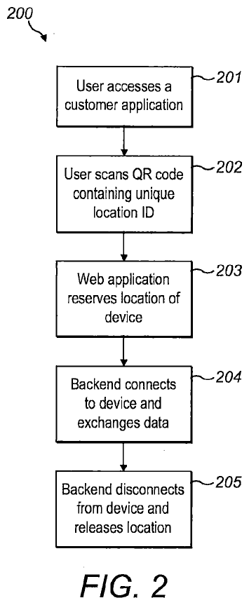

FIG. 2 is a schematic diagram of an example method 200 embodying the invention, which includes a first step 201, wherein a user accesses a customer application, a second step 202, wherein a user scans a QR code containing a unique location ID, a third step 203, wherein a cloud-based web application reserves the peripheral device location, a fourth step 204 wherein a backend service connects a device and exchanges data, and a fifth step 205 wherein a backend disconnects from device and releases location. In preferred embodiments, method 200 facilitates routing print data to a peripheral device, for example to enable a passenger to print a bag tag, a boarding pass and/or a receipt using the peripheral device.

Each of these steps will be described in further detail below.

In Step 201, a user such as a passenger or agent uses a mobile device 101 to access an application to access one or more services provided by an airline or airport, such as checking in, or printing a bag tag. In preferred embodiments, the mobile application is a web application but in other embodiments the application may also be stored on the mobile device.

Accessing the application may involve signing up and logging into the application, which in some embodiments may require entering a username or user ID and password. As customer web application 114 is a cloud service then any authentication steps required by the cloud service provider may also be used. In some embodiments may use an authentication service to authenticate the user based on the entered credentials.

After user login, the configuration service 125 or an authentication services application may determine whether the user is a passenger or a registered agent of the airline or airport. This may be performed by searching a database of logon credentials that only contains the credentials of registered agents, or searching a database of logon credentials for a group identifier, such as an airline identifier.

Once the user has accessed the customer application 114, in Step 202 the user scans a QR code on a peripheral device that they wish to use. For example, the peripheral device may be a scanner, or a bag tag printer. Embedded within the QR code associated with the peripheral device is a unique location ID that is extracted by optically scanning a QR code, or other form of barcode optically displayed on a display screen of the peripheral device, with the mobile device 101. Accordingly, in preferred embodiments a location identifier associated with a location of a peripheral device is obtained by the mobile application via the mobile device. Although typically the location ID will be extracted via optical scanning, it will be appreciated that the location ID may be extracted by the mobile device in other known ways. For example, the mobile device 101 may obtain the location ID by electronically reading the location ID via an RFID tag, Bluetooth beacon, NFC chip or other electronic means associated with the peripheral device.

Next, in Step 203, the customer web application 114 interacts with one or more back-end services to reserve the location of the peripheral device based on the received location identifier. This provides exclusive use by a customer who may be a user, group of users, or an organization (e.g. an airline). For examples, during the time that the location of the peripheral device is reserved for a first airline, no other airline ID may be allowed for connection with the location. Optionally, multiple applications from the same user may use the same location simultaneously. Optionally, the reserved location may be released and become available for use by another user (e.g. another airline), if a disconnection or end-of-session request is received by the user of the existing reservation. Optionally, the reserved location may be released and become available for use by another user in the event of inactivity over a predetermined duration of time. Duration of reservation and/or such a predetermined time may differ depending on the customer, the location and/or peripheral device. Furthermore, there may be instances where multiple peripheral devices are associated with a location, for example a single location may be associated with separate scanning and printing devices. In such instances, preferably all of the devices associated with the location are reserved for the customer's use.

In preferred embodiments, the location is reserved by sending a location reservation API call from the customer application 114 to the API provider 105 in order to exclusively reserve the location of the peripheral device.

In specific embodiments relating to printing operations, the customer application 114 will send a request to an airline DCS 102 via integration service 103 to produce a print string. Alternatively, the customer application 114 will extract information from a customer's PNR to format a print request. The customer application 114 may also retrieve information such as baggage license plate numbers (LPNs) and other passenger-and journey-related information in order to ensure that the printed item, such as a bag tag or boarding pass, is correctly populated.

In a further Step 204, the customer application 114 interacts with one or more backend services 124 to form a connection with the relevant peripheral device at the reserved location. In preferred embodiments, the connection defines a communication route for exchange of data between the customer application and the peripheral device via the API provider 105. For example, the back-end service may route print data, including the relevant retrieved passenger-and journey-related information, to a printing device in order to run the print job. Alternatively, the relevant peripheral device may provide scan data from an associated scanning input device to the customer application via the API provider and back-end service.

In preferred embodiments, the backend services 124 are subscribed to a cloud messaging system, such as the Microsoft Azure Service Bus™, in order to facilitate messaging between the peripheral devices 106, the API provider 105 and the customer application 114. For embodiments that operate within a distributed system, it is possible that the customer and peripheral device are in a different region of the globe to the cloud service provider 104 and/or API provider 105. Accordingly, for the first instance where the customer application 114 is connected with a particular location ID, it is determined in a preliminary step whether the relevant backend service 124 is already subscribed to the appropriate cloud messaging system for that region. If not, the backend service 124 is subscribed to the messaging back channel for that region in order for messages to be correctly routed between the customer application and the peripheral device.

On successfully completion of a job, for example printing a bag tag at the peripheral device, in Step 205 the backend service 124 disconnects from the peripheral devices 106 and releases the reserved location so that it is free for other customers to use.

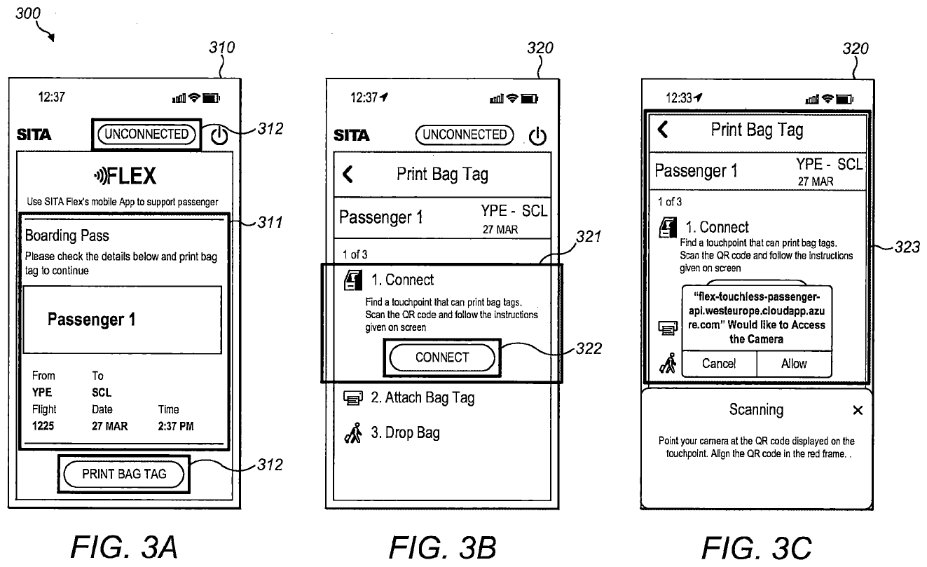

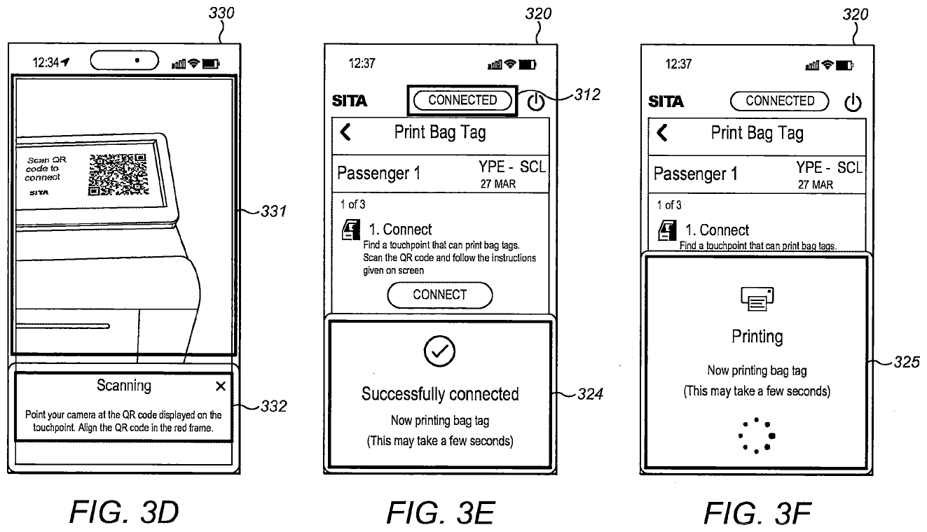

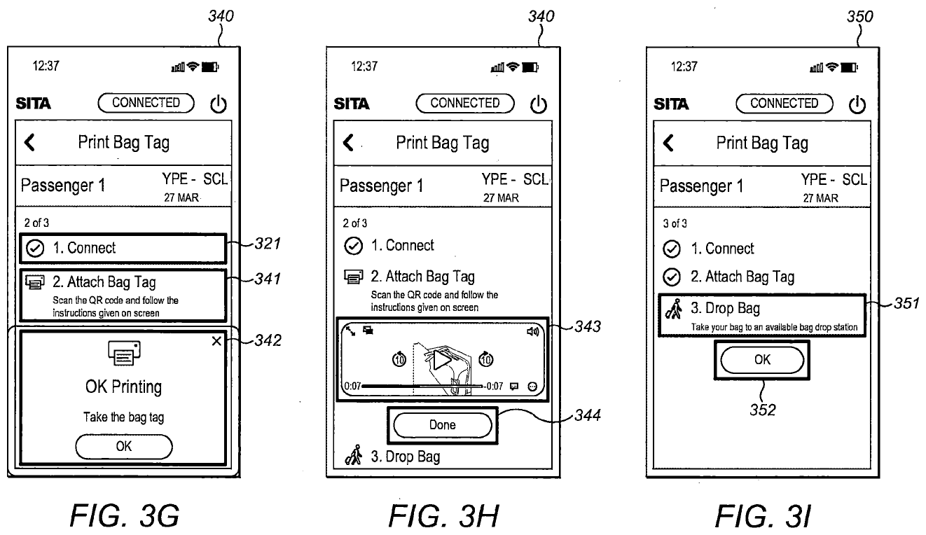

FIGS. 3A to 3I show an example graphical user interface (GUI) 300 for display on a mobile device 101 that enables an application to connect a user with a peripheral device to perform one or more operations described above. As shown in FIGS. 3A to 3I, the GUI comprises a number of pages 310 to 390 for enabling a user to print a bag tag according to embodiments of the invention described herein.

FIG. 3A shows a first GUI page 310 that includes a passenger itinerary, including boarding pass details 311 associated with a passenger, a connection indicium 312 and a print bag tag button 313. It will be appreciated that the passenger itinerary may be retrieved from an identified passenger booking in DCS 102, which then enables the retrieval of passenger-related information such as a PNR, LPN, flight number, airport identifier and departure date, as outlined above. The passenger itinerary may be defined by one or more of a departure airport code, an arrival airport code, a scheduled departure date and time, and a scheduled arrival date and time. In the example of FIG. 3A, the passenger itinerary indicates that the passenger is scheduled to travel from Peace River Airport, Canada (IATA code YPE) to Santiago International Airport, Chile (IATA code SCL) departing on Flight 1225 at 2.37 pm on 27 March.

The retrieved passenger itinerary and passenger-related information allows a boarding pass or bag tag to be issued by the DCS for printing at the peripheral device. It will be appreciated that bag tags and boarding passes may conform to industry standards, such as those defined in IATA RPS documents such as IATA Resolutions and RPs (Recommended Practices) such Baggage Tag IATA Resolution 740 and RP 1740a, and Boarding Pass IATA Resolution 722e and RP 1723.

FIG. 3B shows a second GUI page 320 that displays the first of a number of steps to be performed in order to complete the desired operation. In the example shown in FIG. 3B, the print operation comprises three steps: Connect, Attach Bag Tag, and Bag Drop. The Connect step 321 involves inviting the passenger to find a touchpoint, such as a peripheral printing device, which is able to perform the function of printing a bag tag and to scan a QR code displayed on the device. A Connect button 322 enables the passenger to start the scanning process as further described below.

FIG. 3C shows the second GUI page 320 displaying a pop-up notice 323 that requests authority to access the camera functionality of the mobile device 101.

FIG. 3D shows a third GUI page 330 that displays a camera preview window 331 for obtaining an image of the QR code displayed on the printing device. A status window 332 provides the passenger with directions to scan the QR code with the camera mobile device 101 in order to obtain a location ID associated with the peripheral device.

As described in more detail above, scanning the QR code enables the customer application 114 to obtain the location ID of the peripheral device. This in turn enables the API service 105 to establish a connection between the customer application 114 and the peripheral device 106 via various back-end services 124, and perform a routing function to route data between the correct service and the device service interface of the relevant peripheral device.

FIG. 3E shows the second GUI page 320 displaying a further pop-up notice 324 that indicates that the application has been successfully connected to the selected peripheral device, and that printing of the bag tag is being initiated. Preferably, the connection indicia 312 is configured to indicate the connection status between the app and a peripheral device.

FIG. 3F shows the second GUI page 320 displaying a further pop-up notice 325 that indicates that printing of the bag tag by the peripheral device is in progress. This process may involve sending a print bag tag message to the peripheral device. In some embodiments, this may be done using XSPMAPI messaging protocols that define libraries and communications used by legacy applications. Preferably, the data included within the print bag tag message is based on an AEA format and defines the type of operation to be performed. In this example, the operation to be performed is a print bag tag function.

The payload structure of the message may include data elements that are necessary to print the bag tag. For example, the message may include passenger name, flight number, gate and seat number in an alpha-numeric format. The message may be mapped to a PECTAB template in order to be readable with legacy protocols. A translator API may then translate the message into a format that is suitable for non-legacy protocols. For example, the translator API may create a print bag tag message in JSON format. The message payload further comprises the location ID obtained from the QR code, which is preferably in alpha-numeric format. The location ID is used to identify the peripheral device that the print bag tag message should be routed to.

FIG. 3G shows a fourth GUI page 340 that indicates that the Connect step 321 has been completed, and that the next step to be performed is an Attach Bag Tag step 341. The Attach Bag Step 341 involves inviting the passenger to retrieve the printed bag tag and to follow a set of instructions to correctly attach the bag tag to their baggage. A print status notice 342 notifies the passenger when the bag tag has been printed successfully. The print status notice 342 may be shown in response to receiving a print job completion message.

FIG. 3H shows the fourth GUI page 340 displaying a pop-up window 343 that may enable a short instructional video to be displayed to the passenger to convey instructions for correctly attaching the bag tag to their baggage. Alternatively, the pop-up window 343 may provide a set of written instructions, or instructions provided orally. The fourth GUI page 340 further includes a Done button 344 to enable the passenger to indicate when they have completed the Attach Bag Tag Step 341.

Finally, FIG. 3I shows a fifth GUI page 350 that indicates that the Connect step 321 and Attach Bag Tag step 341 have been completed, and that the final step to be performed is to proceed to a Bag Drop location in step 351. Pressing the OK button 352 returns to the passenger itinerary displayed on the first GUI page 310 in FIG. 3A.

From the foregoing, it will be appreciated that the mobile communication or device may include a computing device, such as a desktop computer, a laptop computer, a tablet computer, a personal digital assistant, a mobile telephone, a smartphone, an internet enabled television, an internet enabled television receiver, an internet enabled games console or portable games device.

It will also be appreciated that this invention finds application as a system for processing a user or customer, a device such as a portable device for use by an agent for processing the customer or a device such as a portable device for use by the passenger, as well as a method or computer program for processing the customer or passenger. In addition, this invention finds application as a system for providing services to a customer or user which may be used by an airline agent or other transport services provider agent.

The server may comprise a computer processor running one or more server processes for communicating with client devices. The server processes comprise computer readable program instructions for carrying out the operations of the present invention. The computer readable program instructions may be or source code or object code written in or in any combination of suitable programming languages including procedural programming languages such as C, object orientated programming languages such as C#, C++, Java, scripting languages, assembly languages, machine code instructions, instruction-set-architecture (ISA) instructions, and state-setting data.

The wired or wireless communication s networks described above may be public, private, wired or wireless network. The communications network may include one or more of a local area network (LAN), a wide area network (WAN), the Internet, a mobile telephony communication system, or a satellite communication system. The communications network may comprise any suitable infrastructure, including copper cables, optical cables or fibres, routers, firewalls, switches, gateway computers and edge servers.

The system described above may comprise a Graphical User Interface. Embodiments of the invention may include an on-screen graphical user interface. The user interface may be provided, for example, in the form of a widget embedded in a web site, as an application for a device, or on a dedicated landing web page. Computer readable program instructions for implementing the graphical user interface may be downloaded to the client device from a computer readable storage medium via a network, for example, the Internet, a local area network (LAN), a wide area network (WAN) and/or a wireless network. The instructions may be stored in a computer readable storage medium within the client device.

As will be appreciated by one of skill in the art, the invention described herein may be embodied in whole or in part as a method, a data processing system, or a computer program product including computer readable instructions. Accordingly, the invention may take the form of an entirely hardware embodiment or an embodiment combining software, hardware and any other suitable approach or apparatus.

The computer readable program instructions may be stored on a non-transitory, tangible computer readable medium. The computer readable storage medium may include one or more of an electronic storage device, a magnetic storage device, an optical storage device, an electromagnetic storage device, a semiconductor storage device, a portable computer disk, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk.

Exemplary embodiments of the invention may be implemented as circuit board which may include a CPU, a bus, RAM, flash memory, one or more ports for operation of connected I/O apparatus such as printers, display, keypads, sensors and cameras, ROM, a communications sub-system such as a modem, and communications media.

The figures illustrate the operation of an example implementation of systems, methods, and computer program products according to various embodiments of the present invention. Each block in the flowchart or block diagrams may represent a module comprising one or more executable computer instructions, or a portion of an instruction, for implementing the logical function specified in the block. The order of blocks in the diagram is only intended to be illustrative of an example. In alternative implementations, the logical functions illustrated in particular blocks may occur out of the order noted in the figures. For example, two blocks shown as adjacent one another may be carried out simultaneously or, depending on the functionality, in the reverse order. Each block in the flowchart may be implemented in software, hardware or a combination of software and hardware.

1. A method for connecting an application to a peripheral device, the method comprising:
receiving a location identifier associated with a location of a peripheral device;
reserving the location of the peripheral device based on the received location identifier, the location being reserved via an application programming interface; and
forming a connection between the application and the peripheral device at the reserved location, the connection defining a route for exchanging data between the application and the peripheral device via the application programming interface.

2. The method of claim 1 further comprising sending print data to the peripheral device, or receiving scan data from the peripheral device.

3. The method of claim 1 wherein the peripheral device is a bag tag printer and/or a boarding pass printer.

4. The method of claim 1 further comprising printing a bag tag, a boarding pass and/or a receipt at the peripheral device.

5. The method of claim 1 further comprising retrieving the location identifier from the peripheral device, and wherein retrieving the location identifier from the peripheral device comprises scanning a barcode displayed on a display screen of the peripheral device.

6. (canceled)

7. The method of claim 1 wherein the application is a web application and the connection between the peripheral device and the web application is formed via the application programming interface.

8. The method of claim 7 further comprising sending a location reservation call from the web application to the application programming interface to reserve the location of the peripheral device and sending a subscription call from the web application to the application programming interface to form an ongoing connection therebetween.

9. (canceled)

10. The method of claim 7 wherein the web application is configured to interact with an airline departure control system to retrieve passenger-related information and to populate the print data with the passenger-related information.

11. The method of claim 10 wherein the web application interacts with the airline departure control system via an integration service.

12. The method of claim 10 further comprising sending a request from the web application to the airline departure control system to produce the print data and receiving the print data at the web application from the airline departure control system for subsequent routing to the peripheral device.

13. (canceled)

14. The method of claim 1 further comprising releasing the reserved location of the peripheral device after executing a print job at the peripheral device based on the print data and mapping one or more peripheral devices with capabilities of the one or more peripheral devices.

15. (canceled)

16. The method of claim 1 further comprising mapping one or more peripheral devices with configurations of the one or more peripheral devices, and wherein the configurations are network interface configurations of the one or more peripheral device.

17. (canceled)

18. The method of claim 16 wherein the configurations relate to COM ports of the one or more peripheral device, and wherein the mapping of the peripheral devices comprises assigning a URL to each of the peripheral devices.

19. (canceled)

20. The method of claim 16 further comprising releasing the reserved location of the peripheral device after executing one or more of the capabilities of the corresponding peripheral device.

21. The method of any claim 1 further comprising releasing the reserved location of the peripheral device after a predetermined period of time of inactivity and/or releasing the reserved location of the peripheral device after receiving a disconnection or end-of-session request is received via the application.

22. (canceled)

23. The method of claim 1 further comprising retrieving a user identifier of a user of the application via the application, wherein the user identifier of the user is identified from a logon event of the application.

24. The method of claim 23 wherein a connection request from another application is declined during the duration of the reservation if the another application is associated with a user identifier that is different from that of the application.

25. The method of claim 23 further comprising retrieving details relating to an organization associated with the user identifier, wherein a connection request from another application is declined during the duration of the reservation if the another application is associated with a user identifier that is not associated with the organization.

26-28. (canceled)

29. A computer program product which, when executed, is configured to perform the method of claim 1.

30. A system for connecting an application to a peripheral device, the system configured to:
receive a location identifier associated with a location of a peripheral device;
reserve the location of the peripheral device based on the received location identifier, the location being reserved via an application programming interface; and
form a connection between the application and the peripheral device at the reserved location, the connection defining a route for exchanging data between the application and the peripheral device via the application programming interface.

31-57. (canceled)
